(19) United States
(12) Patent Application Publication
(10) Pub. No.: US 2026/0011022 A1
(43) Pub. Date: Jan. 8, 2026

(54) System And Method Of Compressing Serial Point Cloud Data

(71) Applicant: FARO Technologies, Inc., Lake Mary, FL (US)

(72) Inventors: Oliver Zweigle, Stuttgart (DE); Matthias Wolke, Korntal-Munchingen (DE)

(21) Appl. No.: 19/259,542

(22) Filed: Jul. 3, 2025

Related U.S. Application Data
(63) Continuation of application No. PCT/US2024/011350, filed on Jan. 12, 2024.
(60) Provisional application No. 63/479,820, filed on Jan. 13, 2023.

(51) Int. Cl. G06T 7/246; G01S 17/42; G01S 17/89; G06T 7/33

(52) U.S. Cl. CPC G06T 7/248; G01S 17/42; G01S 17/89; G06T 7/337; G06T 2207/10024; G06T 2207/10028; G06T 2207/20084; G06T 2207/30168; G06T 2207/30204

(57) ABSTRACT

Examples described herein provide a method that is performed by a processing system. The method includes receiving a first point cloud comprising a first set of points associated with an environment. The first point cloud is organized into a plurality of segments. A second point cloud is received comprising a second set of points associated with the environment. The second point cloud is aligned with at least one of the plurality of segments. A change is identified between at least a portion of the first set of points within the at least one plurality of segments and a corresponding second set of points in the second point cloud. A third point cloud is generated based on the first point cloud, the second point cloud and the change.

### CROSS-REFERENCE TO RELATED APPLICATIONS

This application is a continuation of PCT Application Number PCT/US24/11350, filed Jan. 12, 2024, the entire contents of which are incorporated by reference, and claims priority to U.S. Provisional Application No. 63/479,820, filed Jan. 13, 2023, the entire contents of which are incorporated herein by reference.

### BACKGROUND

The subject matter disclosed herein relates to point cloud versioning.

A collection of 3D coordinate points is sometimes referred to as a point cloud. The 3D coordinate points are collected by any suitable device or system, such as a 3D laser scanner time-of-flight (TOF) coordinate measurement device, a device (e.g., a smartphone) equipped with a light detection and ranging (LIDAR) sensor, a device (e.g., a smartphone) equipped with a camera to capture images and determine 3D coordinate points using photogrammetry, and/or the like, including combinations and/or multiples thereof.

A 3D laser scanner TOF coordinate measurement device is used to acquire 3D data. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism may include a first motor that steers the beam of light about a first axis by a first angle that is measured by a first angular encoder (or other angle transducer). The beam steering mechanism may also include a second motor that steers the beam of light about a second axis by a second angle that is measured by a second angular encoder (or other angle transducer). Other types of beam steering mechanisms include mirror galvanometers.

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

Once acquired, 3D coordinate points are stored for viewing, processing, analyzing, and/or the like, including combinations and/or multiples thereof. While existing techniques for storing 3D coordinate points are suitable for their intended purposes, what is needed is a technique for storing 3D coordinate points having certain features of embodiments described herein.

### BRIEF DESCRIPTION

In accordance with an embodiment, a method is performed by a processing system. The method includes receiving a first point cloud comprising a first set of points associated with an environment. The first point cloud is organized into a plurality of segments. A second point cloud is received comprising a second set of points associated with the environment. The second point cloud is aligned with at least one of the plurality of segments. A change is identified between at least a portion of the first set of points within the at least one plurality of segments and a corresponding second set of points in the second point cloud. A third point cloud is generated based on the first point cloud, the second point cloud and the change.

In accordance with another embodiment, a system is provided. The system includes a memory comprising computer readable instructions. A processing device is provided for executing the computer readable instructions. The computer readable instructions executed by the processing device perform the steps of: receiving a first point cloud comprising a first set of points associated with an environment; receiving a segment of a second point cloud comprising a second set of points associated with the environment; aligning the segment with the first point cloud; identifying a change between the first point cloud and the segment; and generating a third point cloud comprising a third set of points based at least in part on the first point cloud, the segment, and the change between the first point cloud and the segment.

The above features and advantages, and other features and advantages, of the disclosure are readily apparent from the following detailed description when taken in connection with the accompanying drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5 is a flow diagram of a method for point cloud versioning according to one or more embodiments described herein;

FIG. 6A depicts a first scan, a second scan, and a combined model according to one or more embodiments described herein;

FIG. 6B depicts comparing the first scan and the second scan of FIG. 6A according to one or more embodiments described herein;

FIG. 6C depicts multiple scans, including the first scan and the second scan of FIG. 6A, over time according to one or more embodiments described herein; and

FIG. 7 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

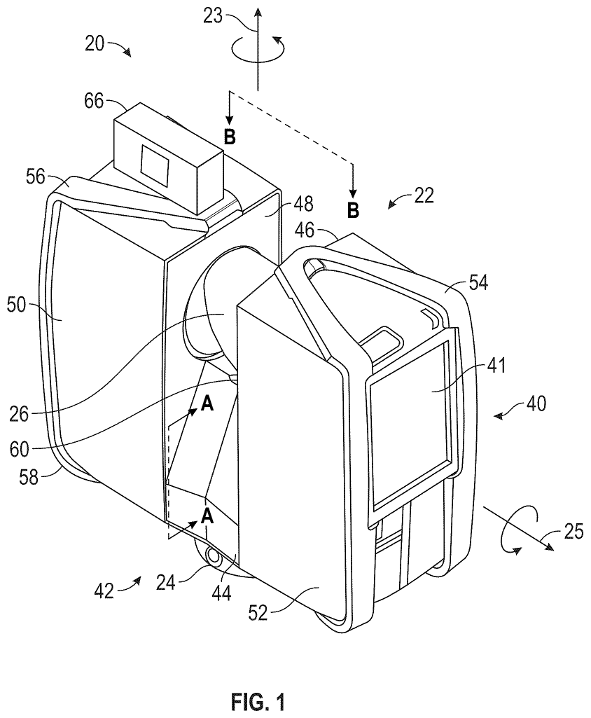

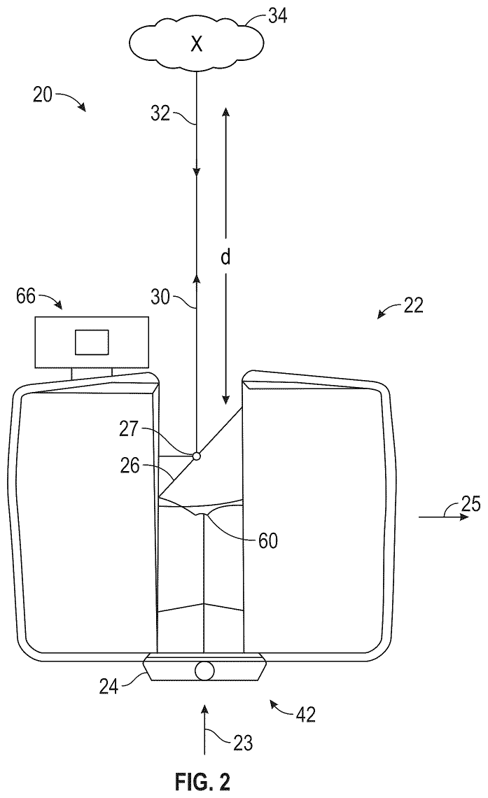

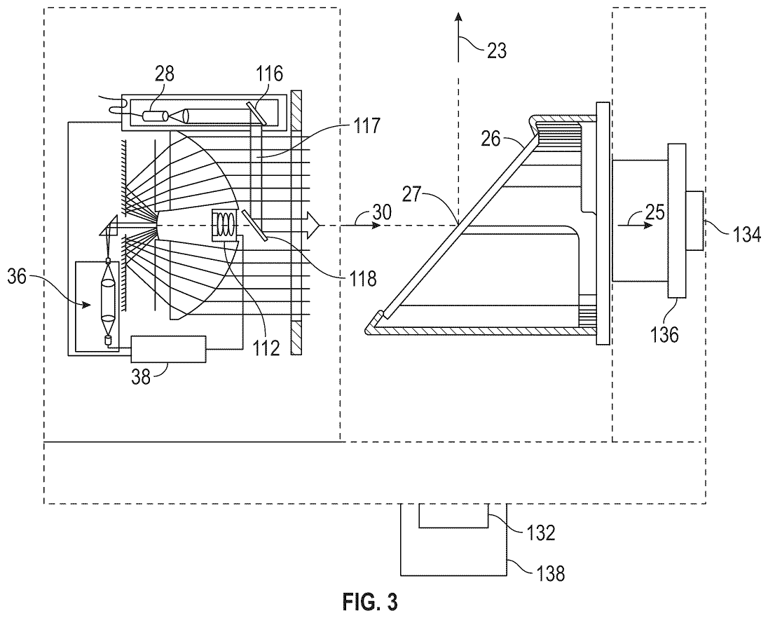

Embodiments described herein provide for point cloud versioning. A collection of 3D coordinate points is sometimes referred to as a point cloud. The 3D coordinate points are collected by any suitable device or system, such as a laser scanner as shown in FIGS. 1-3. It should be appreciated that while embodiments herein refer to a laser scanner, this is for example purposes and the claims should not be so limited. In other embodiments, other types of coordinate measurement devices or combinations of coordinate measurement devices may be used, such as but not limited to triangulation scanners, structured light scanners, a LIDAR sensor-enabled devices, laser line probes, photogrammetry devices, and the like.

Referring now to FIGS. 1-3, a laser scanner 20 is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 is rotated about a vertical axis 23. In one embodiment, the measuring head 22 includes a gimbal point 27 that is a center of rotation about the vertical axis 23 and a horizontal axis 25. The measuring head 22 has a rotary mirror 26, which is rotated about the horizontal axis 25. The rotation about the vertical axis is about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis is substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam has a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 also collects gray-scale information related to the received optical power (equivalent to the term “brightness.”) The gray-scale value is determined at least in part, for example, by integration of the bandpass-filtered and amplified signal in the light receiver 36 over a measuring period attributed to the object point X.

The measuring head 22 includes a display device 40 integrated into the laser scanner 20. The display device 40 includes a graphical touch screen 41, as shown in FIG. 1, which allows the operator to set the parameters or initiate the operation of the laser scanner 20. For example, the screen 41 has a user interface that allows the operator to provide measurement instructions to the device, and the screen also displays measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 are coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which is measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 is used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 is a device that captures and measures a parameter associated with the scanned area or the scanned object and provides a signal representing the measured quantities over an image acquisition area. The auxiliary image acquisition device 66 is, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and has the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 is a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains two-dimensional (2D) images of the scanned area to capture color data to add to the scanned image. In the case of a built-in color camera having an optical axis coincident with that of the 3D scanning device, the direction of the camera view is easily obtained by simply adjusting the steering mechanisms of the scanner-for example, by adjusting the azimuth angle about the axis 23 and by steering the mirror 26 about the axis 25.

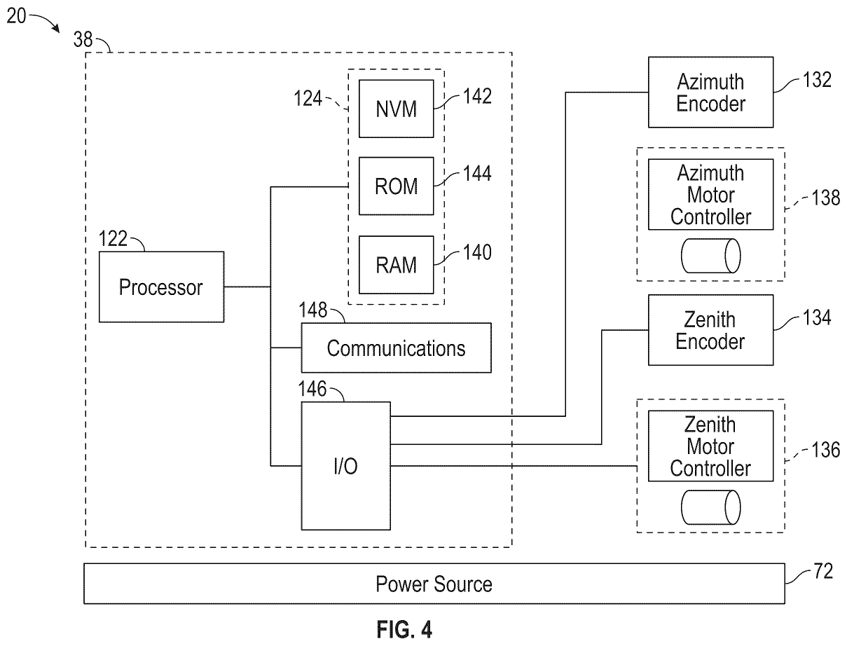

Referring now to FIG. 4 with continuing reference to FIGS. 1-3, elements are shown of the laser scanner 20. Controller 38 is a suitable electronic device capable of accepting data and instructions, executing the instructions to process the data, and presenting the results.

The controller 38 includes one or more processing elements 122. The processors are microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 is displayed on a user interface 40 coupled to controller 38. In an embodiment, the user interface 40 is one or more LEDs (light-emitting diodes) 82, an LCD (liquid-crystal diode) display, a CRT (cathode ray tube) display, a touch-screen display or the like. In an embodiment, a keypad is coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 is also coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet Protocol), RS-232, ModBus, and the like. In an embodiment, additional systems 20 are connected to LAN with the controllers 38 in each of these systems 20 being configured to send and receive data to and from remote computers and other systems 20. The LAN is connected to the Internet. This connection allows controller 38 to communicate with one or more remote computers connected to the Internet.

The processors 122 are coupled to memory 124. The memory 124 includes random access memory (RAM) device 140, a non-volatile memory (NVM) device 142, and a read-only memory (ROM) device 144. In addition, the processors 122 are connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software is encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

According to one or more embodiments, the controller 38 is communicatively coupled to or otherwise include an inertial measurement unit (IMU) (not shown). For example, the laser scanner 20 can include elements of an IMU, namely accelerometers and gyroscopes, and in some embodiments include: magnetometers, pressure sensors, and global positioning systems (GPS). Accelerometers, which also serve as inclinometers, include be three-axis accelerometers that provide acceleration and inclination information in three dimensions. Gyroscopes include three-axis gyroscopes that measure rotational velocity in three dimensions. Magnetometers provide heading information, that is, information about changes in direction in a plane perpendicular to the gravity vector. Because magnetometers are affected by magnetic fields, their performance is compromised in industrial environments by the relatively large magnetic fields generated by motors and other industrial equipment. Pressure sensors, which also serve as altimeters, determine elevation, for example, to determine a number of a floor within a multi-story building. GPS sensors and other related sensors such as GLONASS measure locations anywhere on earth. Accuracy of such sensors varies widely depending on the implementation. A potential problem with GPS is the potential for it being blocked inside buildings. Indoor GPS, which does not actually use the global positioning system, is becoming available in different forms today to provide location information when GPS is blocked by buildings. In an embodiment, the sensors described hereinabove are used separately or combined together in a single laser scanner (e.g., the laser scanner 20). The data provided multiple sensors within a laser scanner is processed using Kalman filters and/or other mathematical techniques to improve calculated values for position and orientation of the laser scanner over time.

Embodiments of techniques for point cloud versioning are now described. Devices that capture three-dimensional (3D) data, such as the laser scanner 20, is used to scan environments and create point clouds that are used to visualize the environment. Some environments are scanned at different points in time to visualize changes over time. For example, a laser scanner can scan a construction site (e.g., a building) at different points in time during construction, and the data acquired by these scans is compared to visualize progress of construction, document building information, estimate inventory levels, and/or the like, including combinations and/or multiples thereof.

In such cases, multiple scans, each with many points (e.g., hundreds of millions or even billions of points), need to be stored. Storage of these scans uses significant computing resources (e.g., memory, processing, data storage, bandwidth, and/or the like, including combinations and/or multiples thereof). If a user wants to compare two point clouds from two different scans (e.g., two different points in time), both point clouds need to be stored and transmitted, such as from a cloud computing system, to a user device (e.g., smartphone) associated with the user. This uses significant resources in terms of data storage (e.g., storing two point clouds) and bandwidth (e.g., transferring two point clouds). Further, users often have to view multiple, partial point clouds from data captured at different points in time and different locations of an environment. For example, a user has a need to work with a complete point cloud, which is recorded with different devices at different points in time.

One or more embodiments described herein address these and other shortcomings by providing for point cloud versioning. According to an embodiment, when a new point cloud is captured or acquired, it is analyzed and compared to an old point cloud to identify changes between the old and new point clouds. The changes are identified and stored without storing redundant/duplicate data between the old and new point clouds. This improves computer functionality by reducing the amount of data that needs to be stored and transmitted, for example, since redundant/duplicate data are not stored and/or transmitted. Similarly, if changes are made to a point cloud manually, such as by a user, the techniques for point cloud versioning described herein is applied to reduce data storage. According to one or more embodiments described herein, the provided point cloud is more complete than the conventional, multiple, partial point clouds from data captured at different points in time and different locations of an environment. Particularly, one or more embodiments provide the ability to display and interact with actual and complete point clouds.

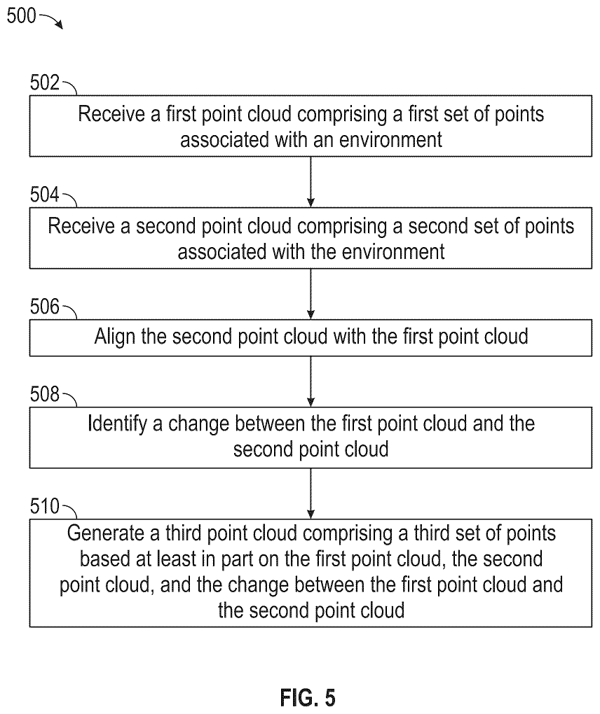

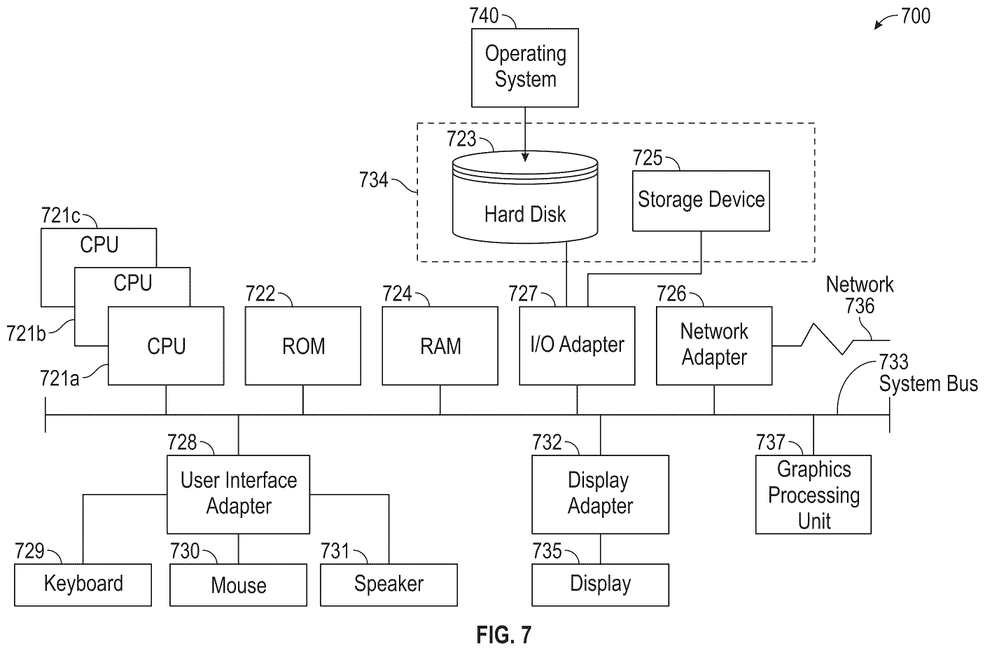

FIG. 5 illustrates a flow diagram of a method 500 for point cloud versioning according to one or more embodiments described herein. The method 500 is performed by any suitable system or device, such as controller 38, a smartphone, a tablet computer, a laptop computer, a desktop computer, a wearable computing device, a head-up display, and/or the like, including combinations and/or multiples thereof. According to an embodiment, the processing system 700 of FIG. 7 is used to implement the method 500, but the method 500 is not so limited.

With reference to FIG. 5, at block 502, a processing system receives a first point cloud that includes a first set of points associated with an environment. According to an embodiment, the environment is a building or other facility that changes over time, such as a construction site, a warehouse, a factory, and/or the like, including combinations and/or multiples thereof. The first set of points are 3D coordinates measured by a 3D coordinate measurement device, such as the laser scanner 20.

At block 504, the processing system receives a second point cloud that includes a second set of points associated with the environment. The first set of points are 3D coordinates measured by a 3D coordinate measurement device, such as the laser scanner 20 or another suitable device. According to one or more embodiments described herein, the second point cloud is captured at a later point in time relative to when the first point cloud was captured.

At block 506, the processing system aligns the second point cloud to the first point cloud. Alignment, also referred to as registration, involves matching points of the second set of points of the second point cloud to corresponding points from the first set of points of the first point cloud. It should be appreciated that the matching of the point clouds does not involve a one-to-one correspondence between the first set of points of the first point cloud with the second set of points in the second point cloud. In some embodiments, this is performed using markers/spheres or known feature points (e.g., points within the environment that are known not to change over time), such as by using a best-fit method for example. According to one or more embodiments described herein, the aligning can include locating actual areas of overlap between the first point cloud and the second point cloud. According to one or more embodiments described herein, the aligning can include performing processing on the second set of points of the second point cloud, such as to reduce noise, fill holes/gaps, calculate normal vector information, and/or the like, including combinations and/or multiples thereof. According to one or more embodiments described herein, the aligning is based at least in part on 3D information.

At block 508, the processing system identifies changes between the first point cloud and the second point cloud. Changes could indicate an addition to the environment (e.g., the addition of a wall to a building) or a removal from the environment (e.g., the removing of a wall of a building). According to one or more embodiments described herein, the processing system can compare the identified change to a change threshold to determine whether to include the change in a third point cloud (block 510). Comparing the change to the change threshold can prevent minor changes from being included to the third point cloud, where such changes are insignificant or are not representative of actual changes to the environment (e.g., a minor change due to an environmental condition during the scan, measurement noise, or moving objects like human or cars). The change threshold is applied on the whole point cloud or only part of the point cloud, for example, a number of changed points, a number of changed points within a certain area or volume, a certain area or volume covered by the changed points, a distance (e.g., a distance between two corresponding points), a color or gray-scale difference where the color or gray-scale information is available, a measurement quality (e.g., the quality of the point satisfies a quality threshold, indicating that the point is a valid point (e.g., not noise)), and/or the like, including combinations and/or multiples thereof. For example, machine learning (e.g., parametric and/or non-parametric) is applied to one or more portions/regions of the point cloud, where other portions/regions of the point cloud is ignored or removed for purposes of analysis. As another example, a portion or region of the point cloud could also mean the portion where overlap between the first and the second point clouds exist, thus machine learning as described herein is applied to the overlap portion without performing the analysis on the full point cloud According to one or more embodiments described herein, identifying changes includes identifying similarities between the first point cloud and the second point cloud and identifying differences between the first point cloud and the second point cloud. According to one or more embodiments described herein, identifying the differences and similarities is performed for volumes or regions where both the first and second point clouds are populated with measurement data. According to one or more embodiments described herein, identifying the differences and similarities is based at least in part on 3D coordinates of the first set of points of the first point cloud.

According to one or more embodiments described herein, the processing system can classify the identified change. Examples of such classifications can include an element added to, removed from, or moved with respect to, the environment, and/or the like, including combinations and/or multiples thereof. According to one or more embodiments described herein, the processing system can implement machine learning techniques to classify the change. More specifically, one or more embodiments described herein can incorporate and utilize rule-based decision making and artificial intelligence (AI) reasoning to accomplish the various operations described herein, namely classifying changes to a point cloud. The phrase “machine learning” broadly describes a function of electronic systems that learn from data. A machine learning system, engine, or module can include a trainable machine learning algorithm that is trained, such as in an external cloud environment, to learn functional relationships between inputs and outputs, and the resulting model (sometimes referred to as a “trained neural network,” “trained model,” and/or “trained machine learning model”) is used for classifying changes to a point cloud, for example. In one or more embodiments, machine learning functionality is implemented using an artificial neural network (ANN) having the capability to be trained to perform a function. In machine learning and cognitive science, ANNs are a family of statistical learning models inspired by the biological neural networks of animals, and in particular the brain. ANNs are used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and may be used in accordance with one or more embodiments described herein.

ANNs are embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights are adjusted and tuned based on experience, making ANNs adaptive to inputs and capable of learning. For example, an ANN for handwriting recognition is defined by a set of input neurons that are activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques are applied in the case of classifying changes to a point cloud as described herein.

With continued reference to FIG. 5, at block 510, the processing system generates a third point cloud that includes a third set of points based at least in part on the first point cloud, the second point cloud, and the identified change between the first point cloud and the second point cloud. The third point cloud, also referred to as a “model,” represents a combination of the first point cloud and the second point cloud. For example, duplicate information between the first point cloud and the second point cloud is removed. Information not present in the second point cloud is removed or archived. For example, removed objects from the first point cloud are tagged (e.g., with metadata indicating a timestamp, a classification, and/or the like, including combinations and/or multiples thereof) and stored separately for archival purposes. New information in the second point cloud that was not in the first point cloud is added. New information is tagged or otherwise indicated as being new. By generating the third point cloud (“model”) based on the first point cloud, the second point cloud, and the change between the first point cloud and the second point cloud, identified changes are stored without storing redundant/duplicate data between the old and new point clouds (e.g., the first point cloud and the second point cloud, respectively). This improves computer functionality by reducing the amount of data that needs to be stored and transmitted, for example, since redundant/duplicate data are not stored and/or transmitted.

In an embodiment, additional processes are included, and it should be understood that the process depicted in FIG. 5 represents an illustration, and that in other embodiments, other processes are added or existing processes are removed, modified, or rearranged without departing from the scope of the present disclosure.

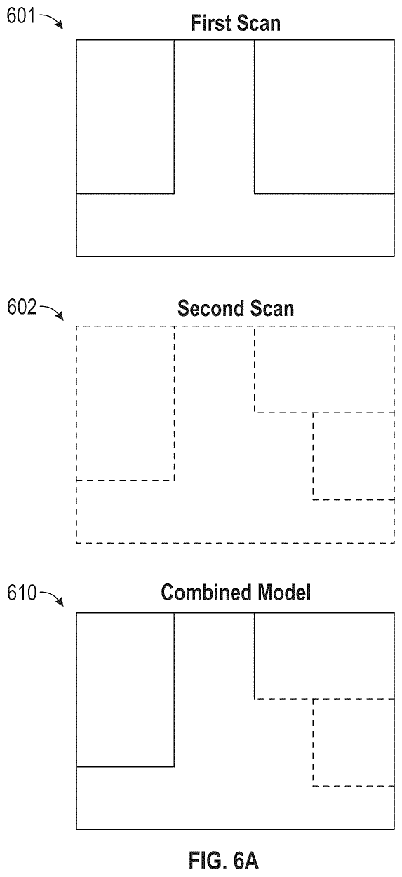

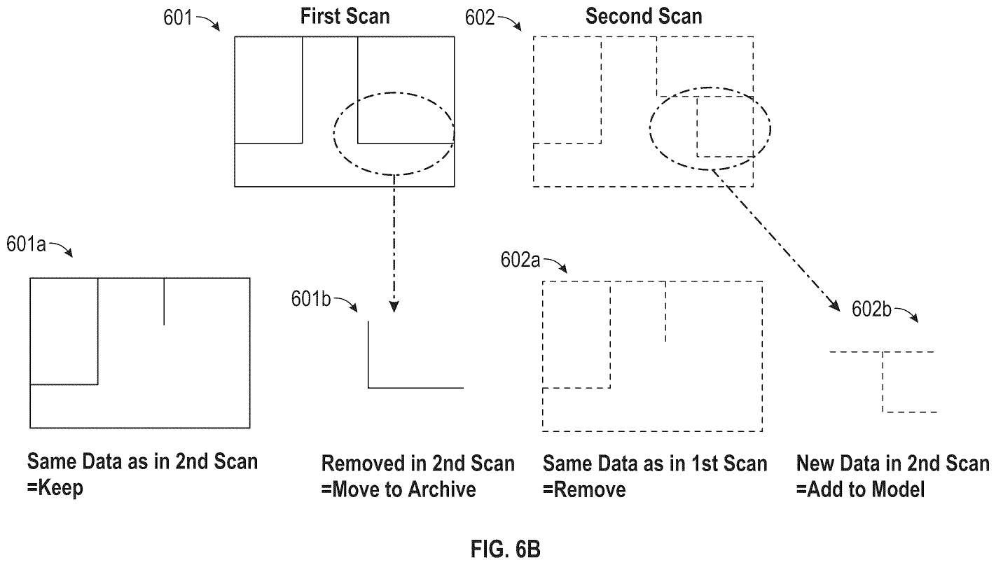

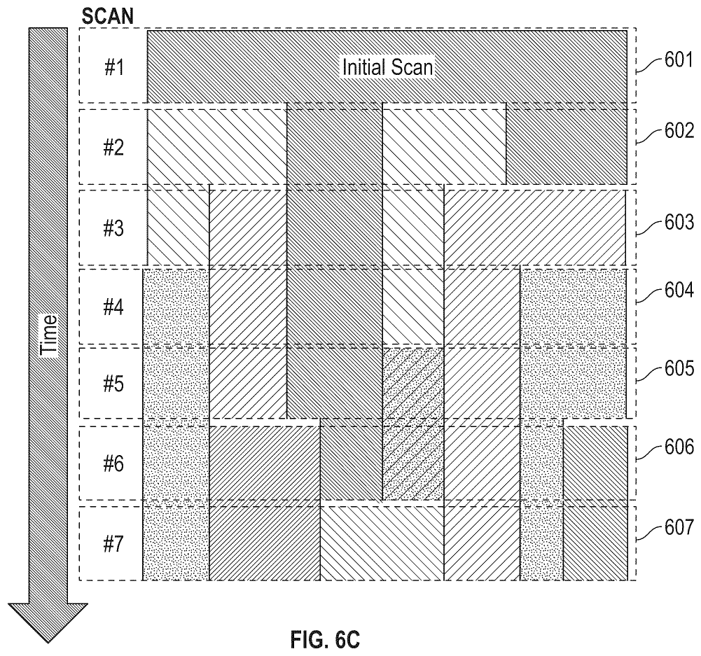

FIGS. 6A, 6B, and 6C are now described as an example of the first point cloud and second point cloud described with respect to FIG. 5. It should be appreciated that the method 500 is not so limited, and that FIGS. 6A-6C represent mere examples. It should further be appreciated that, in FIGS. 6A-6C, each image shows a 2D section through a 3D point cloud (e.g., a floor plan) for clarity only, and it should be appreciated that the embodiments described herein apply to at least 2D data and 3D data.

FIG. 6A depicts a first scan 601, a second scan 602, and a combined model 610 according to one or more embodiments described herein. The first scan 601 represents the first point cloud captured at a first point in time, the second scan 602 represents the second point cloud captured at a second point in time, and the combined model 610 represents the third point cloud. In this example, it is observed that, from the first point in time to the second point in time, walls were added and removed from the environment that was scanned. The combined model 610 shows the data from the first scan 601 modified by the new data from the second scan 602.

This is seen in more detail in FIG. 6B, which depicts comparing the first scan 601 and the second scan 602 according to one or more embodiments described herein. In this example, the first scan 601 is compared to the second scan 602 to identify changes between the first scan 601 and the second scan 602 (see, e.g., FIG. 5, block 508). Data 601a that are the same between the first and second scans 601, 602 are maintained in the first scan 601. Data 601b that are different between the first and second scans 601, 602 are removed from the first scan 601. It should be appreciated that the removed data is archived and/or tagged with metadata to associate the data 601b with the first scan 601. Data 602a that are the same between the first and second scans 601, 602 are removed from the second scan 602. Data 602b that are different between the first and second scans 601, 602 are added to the data 601a to generate the combined model 610 (e.g., a new point cloud).

Multiple scans (e.g., point clouds) are captured over time, as shown in FIG. 6C, for example. In particular, FIG. 6C depicts multiple scans, including the first scan 601 and the second scan 602, over time according to one or more embodiments described herein. In this example, seven scans (e.g., scan 601, scan 602, scan 603, scan 604, scan 605, scan 606, scan 607) are depicted. Each of the scans 601-607 is captured at a different point in time (e.g., the scan 601 is captured at a first point in time, the scan 602 is captured at a second point in time, the scan 603 is captured at a third point in time, etc.). For each scan, a difference (e.g., changes) to a previous scan is calculated, and the portions (e.g., segments) with changes are replaced by the data from the new scan. As is seen in FIG. 6C, each newly added data that replaces old data is marked with a different filling style. For example, when a model (e.g., the third point cloud at block 510 of FIG. 5) is generated for the time of scan 602, the model includes data from two scans: scan 601 as a solid style and scan 602 as a dotted style. When a model is generated for the time of scan 606, the model includes data from five scans: scan 601 as a solid style, scan 603 as a diagonal lined style, scan 604 as a horizontal lines style, scan 605 as a crossed lines style, and scan 606 as a vertical lines style.

Further features of one or more embodiments described herein are now described.

According to an embodiment, it is useful to organize the data from the scans (e.g., point clouds) in segments, where each segment represents a logical connected part of the full point cloud. This is a wall/ceiling/plane, a corner, an object, a freeform surface, and/or the like, including combinations and/or multiples thereof. Hence, the archive (e.g., where removed parts are stored) is a collection of such segments with associated attributes like timestamps and quality measures. Each segment is larger than the actual identified changed region in some cases, and a region growing algorithm could be used to avoid having voids when reconstructed. In the model, which is a collection of different segments, this mitigates possible issues with inaccurate data or alignment. In examples, the segments are not strictly fixed and are divided into smaller segments, such as when only parts of this change in a later scan.

According to an embodiment, a scan is a partial scan. For example, with reference to the example of FIG. 5, the second point cloud does not cover the same region of the environment as the first point cloud. A subset or a new region is part of the added scan (e.g., the second point cloud). To avoid false change detection, in some embodiments a method to identify overlapping regions is used. One example of such a method is based on cloud-to-cloud comparison, where the existing and the new point clouds are compared and points of the existing dataset with a distance above a defined threshold are considered to be not existent in the added dataset (and vice versa). In some cases, this is true only if the distance values (e.g., geometrical distance between point clusters) do continuously increase in at least one direction. Additionally or alternatively, the knowledge about the scan positions (e.g., for a stationary scanning system) or scan trajectory (e.g., for a mobile scanning system) is used to determine overlapping areas. Any unique data, such as data that is not present in the first point cloud or second point cloud is directly stored (e.g., locally, to a cloud computing system, and/or the like, including combinations and/or multiples thereof) and used in the model (e.g., the third point cloud from block 510 of FIG. 5).

According to an embodiment, measurement quality can also be considered when identifying changes between two point clouds. For example, each scan iteration is tagged with a quality value. The quality value is calculated (e.g., based on a statistical point cloud analysis, based on analysis of geometrical features, and/or the like, including combinations and/or multiples thereof), determined based on the type of 3D coordinate measurement device (e.g., high quality for terrestrial laser scan, medium quality for mobile mapping, low quality for smartphone based scan, and/or the like, including combinations and/or multiples thereof), or manually set. The measurement quality is based on noise, point density, expected accuracy, and/or the like, including combinations and/or multiples thereof. The quality values are stored individually and associated with the respective scans and are evaluated individually or combined based on the use case. According to one or more embodiments described herein, the portion of a point cloud having a highest quality is stored. For example, if a certain wall in a building is first scanned with a medium quality value and later measured with a high-quality value, but no changes in the geometry are being detected, the points from the later high-quality scan is stored and the initial measurement data is removed. According to one or more embodiments described herein, overlap sections are kept that have the higher quality based on lower noise level, higher accuracy, high/medium/low quality, and/or the like, including combinations and/or multiples thereof.

According to one or more embodiments described herein, when multiple users add different new scans (e.g., new point clouds), so called “collisions” happen when two users add new data for the same region. That is, two or more overlapping point clouds have a wrong submission order in that a first point cloud is captured at a first point in time but uploaded after a second point cloud that was captured at a second, later, point in time. Due to the nature of the data, these collisions are recognized and automatically resolved (e.g., using time stamps) when the data remains a representation of reality (e.g., no manual change has been applied). For example, a first user adds a first point cloud, and a second user adds a second point cloud. The first user adds the first point cloud at a time before the second user adds the second point cloud, but the second point cloud is actually older than (e.g., captured before) the first point cloud. In this situation, the second point cloud is not used to update the model but, based on the timestamps, to the stored model at the time the point cloud was recorded. This does not alter the most recent stored model but does add another timestamp for which a 3D model is calculated.

According to one or more embodiments described herein, for each timestamp where at least a portion of the object or scenery has been scanned, a 3D model is generated. This allows the user to inspect changes over time or object conditions at a specific time. Each point cloud segment, as described herein, can have a “time of validity” that spans from the timestamp of recording to the timestamp of a subsequent recording that replaces the segment. This enables the selection of correct point cloud segments based on any given timestamp.

According to one or more embodiments described herein, a last added point cloud is stored unaltered/unfiltered especially without removal of redundant data. In contrast to this, the identification of changes are performed locally and only incremental updates are transferred to the cloud storage in embodiments. This reduces or minimizes the amount of transferred data for the user and also reduces or minimizes the processing resources needed on the nodes of the cloud-based computing system.

According to one or more embodiments described herein, local point cloud alignment is performed between new data and existing data. For example, when the global accuracy of any one dataset is low, a local comparison can help to identify real changes. This accounts for changes in accuracy between different measurement accuracies of data measured by two different devices or approaches (e.g., laser scanner versus a smartphone LIDAR sensor).

According to one or more embodiments described herein, when color information (e.g., 2D images) for point cloud colorization are not recorded in a scan, the color information from a first scan with associated images are transferred or mapped to the data of a second scan.

According to one or more embodiments described herein, redundant data from one scan is not directly removed, but the data is combined for a more complete and accurate digital representation. This provides for homogenized point distribution, lowered noise, increased level of detail, and/or the like, including combinations and/or multiples thereof. Using this approach, selected holes (e.g., regions of low point density) are filled and then redundancy is used for cross checking and error compensation.

According to one or more embodiments described herein, specific regions having one or more identified segments with frequent changes are identified. This could automatically detect and highlight certain regions of interest to a user.

It is understood that one or more embodiments described herein is capable of being implemented in conjunction with any other type of computing environment now known or later developed. For example, FIG. 7 depicts a block diagram of a processing system 700 for implementing the techniques described herein. In accordance with one or more embodiments described herein, the processing system 700 is an example of a cloud computing node of a cloud computing system. In examples, processing system 700 has one or more central processing units (“processors” or “processing resources” or “processing devices”) 721a, 721b, 721c, etc. (collectively or generically referred to as processor(s) 721 and/or as processing device(s)). In aspects of the present disclosure, each processor 721 can include a reduced instruction set computer (RISC) microprocessor. Processors 721 are coupled to system memory (e.g., random access memory (RAM) 724) and various other components via a system bus 733. Read only memory (ROM) 722 is coupled to system bus 733 and includes a basic input/output system (BIOS), which controls certain basic functions of processing system 700.

Further depicted are an input/output (I/O) adapter 727 and a network adapter 726 coupled to system bus 733. I/O adapter 727 is a small computer system interface (SCSI) adapter that communicates with a hard disk 723 and/or a storage device 725 or any other similar component. I/O adapter 727, hard disk 723, and storage device 725 are collectively referred to herein as mass storage 734. Operating system 740 for execution on processing system 700 is stored in mass storage 734. The network adapter 726 interconnects system bus 733 with an outside network 736 enabling processing system 700 to communicate with other such systems.

A display (e.g., a display monitor) 735 is connected to system bus 733 by display adapter 732, which includes a graphics adapter to improve the performance of graphics intensive applications and a video controller. In one aspect of the present disclosure, adapters 726, 727, and/or 732 are connected to one or more I/O busses that are connected to system bus 733 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 733 via user interface adapter 728 and display adapter 732. A keyboard 729, mouse 730, and speaker 731 are interconnected to system bus 733 via user interface adapter 728, which includes, for example, a Super I/O chip integrating multiple device adapters into a single integrated circuit.

In some aspects of the present disclosure, processing system 700 includes a graphics processing unit 737. Graphics processing unit 737 is a specialized electronic circuit designed to manipulate and alter memory to accelerate the creation of images in a frame buffer intended for output to a display. In general, graphics processing unit 737 is very efficient at manipulating computer graphics and image processing, and has a highly parallel structure that makes it more effective than general-purpose CPUs for algorithms where processing of large blocks of data is done in parallel.

Thus, as configured herein, processing system 700 includes processing capability in the form of processors 721, storage capability including system memory (e.g., RAM 724), and mass storage 734, input means such as keyboard 729 and mouse 730, and output capability including speaker 731 and display 735. In some aspects of the present disclosure, a portion of system memory (e.g., RAM 724) and mass storage 734 collectively store the operating system 740 to coordinate the functions of the various components shown in processing system 700.

In one exemplary embodiment, a method is provided. The method includes receiving, by a processing system, a first point cloud including a first set of points associated with an environment. The method further includes receiving, by the processing system, a second point cloud including a second set of points associated with the environment. The method further includes aligning, by the processing system, the second point cloud with the first point cloud. The method further includes identifying, by the processing system, a change between the first point cloud and the second point cloud. The method further includes segmenting, by the processing system, at least one of the first point cloud or the second point cloud into point cloud segments. Identifying the change between the first point cloud and the second point cloud is performed on the point cloud segments.

In addition to one or more of the features described herein, or as an alternative, further embodiments of the method includes that at least one of the first set of points or the second set of points are captured by a 3D coordinate measurement device.

In addition to one or more of the features described herein, or as an alternative, further embodiments of the method includes that the 3D coordinate measurement device is a laser scanner.

In addition to one or more of the features described herein, or as an alternative, further embodiments of the method includes that the aligning includes matching points of the second set of points of the second point cloud to corresponding points from the first set of points of the first point cloud, and wherein the aligning is performed using markers located within the environment or known feature points within the environment.

In addition to one or more of the features described herein, or as an alternative, further embodiments of the method includes that the change is selected from a group consisting of an element added to the environment, an element removed from the environment, and element moved with respect to the environment.

In addition to one or more of the features described herein, or as an alternative, further embodiments of the method includes comparing the change to a change threshold, to determine whether to include the change in the third point cloud, wherein the change is included in the third point cloud when the change satisfies the change threshold.

In addition to one or more of the features described herein, or as an alternative, further embodiments of the method includes that the change threshold is selected from a group consisting of a number of changed points, a number of changed points within a certain area or volume, a distance, a color difference, and a measurement quality.

In addition to one or more of the features described herein, or as an alternative, further embodiments of the method includes that the first set of points are captured at a first point in time, and wherein the second set of points are captured at a second point in time later than the first point in time.

In addition to one or more of the features described herein, or as an alternative, further embodiments of the method includes: receiving, by the processing system, a fourth point cloud including a fourth set of points associated with the environment; aligning, by the processing system, the fourth point cloud with the third point cloud; identifying, by the processing system, a change between the third point cloud and the fourth point cloud; and generating, by the processing system, a fifth point cloud including a fifth set of points based at least in part on the third point cloud, the fourth point cloud, and the change between the third point cloud and the fourth point cloud.

In addition to one or more of the features described herein, or as an alternative, further embodiments of the method includes generating, by the processing system, a third point cloud including a third set of points based at least in part on the first point cloud, the second point cloud, and the change between the first point cloud and the second point cloud.

In addition to one or more of the features described herein, or as an alternative, further embodiments of the method includes determining overlapping regions between the first point cloud and the second point cloud using a cloud-to-cloud comparison technique.

In addition to one or more of the features described herein, or as an alternative, further embodiments of the method includes that generating the third point cloud is further based at least in part on a first quality value associated with the first point cloud and a second quality value associated with the second point cloud, wherein the first quality value and the second quality value are determined based at least in part on a type of device used to collect each of the first set of points for the first point cloud and the second set of points or the second point cloud.

In addition to one or more of the features described herein, or as an alternative, further embodiments of the method includes detecting a collision between the first point cloud and the second point cloud based at least in part on a timestamp associated with each of the first point cloud and the second point cloud.

In addition to one or more of the features described herein, or as an alternative, further embodiments of the method includes storing the third point cloud to a cloud computing system.

In another exemplary embodiment a system includes a memory having computer readable instructions and a processing device for executing the computer readable instructions. The computer readable instructions control the processing device to perform operations. The operations include receiving a first point cloud including a first set of points associated with an environment. The operations further include receiving a second point cloud including a second set of points associated with the environment. The operations further include aligning the second point cloud with the first point cloud. The operations further include identifying a change between the first point cloud and the second point cloud. The operations further include generating a third point cloud including a third set of points based at least in part on the first point cloud, the second point cloud, and the change between the first point cloud and the second point cloud.

In addition to one or more of the features described herein, or as an alternative, further embodiments of the system includes that the aligning includes matching points of the second set of points of the second point cloud to corresponding points from the first set of points of the first point cloud, and wherein the aligning is performed using markers located within the environment or known feature points within the environment.

In addition to one or more of the features described herein, or as an alternative, further embodiments of the system includes that the change is selected from a group consisting of an element added to the environment, an element removed from the environment, and element moved with respect to the environment.

In addition to one or more of the features described herein, or as an alternative, further embodiments of the system includes that the operations further include comparing the change to a change threshold, to determine whether to include the change in the third point cloud, wherein the change is included in the third point cloud when the change satisfies the change threshold.

In addition to one or more of the features described herein, or as an alternative, further embodiments of the system includes that the change threshold is selected from a group consisting of a number of changed points, a number of changed points within a certain area or volume, a distance, a color difference, and a measurement quality.

In addition to one or more of the features described herein, or as an alternative, further embodiments of the system includes that the first set of points are captured at a first point in time, and wherein the second set of points are captured at a second point in time later than the first point in time.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure are modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

1. A method performed by a processing system, the method comprising:
receiving a first point cloud comprising a first set of points associated with an environment;
organizing the first point cloud into a plurality of segments;
receiving a second point cloud comprising a second set of points associated with the environment;
aligning the second point cloud with at least one of the plurality of segments;
identifying a change between at least a portion of the first set of points within the at least one of the plurality of segments and a corresponding second set of points in the second point cloud; and
generating a third point cloud based on the first point cloud, the second point cloud and the change;
wherein generating the third point cloud is further based at least in part on a first quality value associated with the first point cloud and a second quality value associated with the second point cloud, and the first quality value and the second quality value are determined based at least in part on a type of device used to collect the first set of points of the first point cloud and the second set of points of the second point cloud.

2. The method of claim 1, wherein at least one of the first set of points and the second set of points are captured by a 3D coordinate measurement device.

3. The method of claim 2, the 3D coordinate measurement device comprising a laser scanner.

4. The method of claim 1, wherein the aligning comprises matching points of the second set of points of the second point cloud to corresponding points in at least one of the plurality of segments of the first point cloud, and the aligning is performed using markers located within the environment or known feature points within the environment.

5. The method of claim 1, wherein the change comprises at least one of an element added to the environment, an element removed from the environment, and an element moved within the environment.

6. The method of claim 1, further comprising:
comparing the change to a change threshold, to determine whether to include the change in the third point cloud, and
including the change in the third point cloud when the change satisfies the change threshold.

7. The method of claim 6, wherein the change threshold is based on at least one of a number of changed points, a number of changed points within a certain area or volume, a distance, a color difference, and a measurement quality.

8. The method of claim 1, wherein the first set of points are captured at a first point in time, and the second set of points are captured at a second point in time later than the first point in time.

9. The method of claim 1, further comprising:
receiving, by the processing system, a fourth point cloud comprising a fourth set of points associated with the environment;
aligning, by the processing system, the fourth point cloud with the third point cloud;
identifying, by the processing system, a change between the third point cloud and the fourth point cloud; and
generating, by the processing system, a fifth point cloud comprising a fifth set of points based at least in part on the third point cloud, the fourth point cloud, and the change between the third point cloud and the fourth point cloud.

10. The method of claim 1, the generating based at least in part on the first point cloud, the second point cloud, and the change.

11. The method of claim 1, further comprising determining overlapping regions between the first point cloud and the second point cloud using cloud-to-cloud comparison.

12. The method of claim 1, wherein the first quality value and the second quality value are determined based at least in part on at least one of: a type of scan used to collect the first set of points of the first point cloud and the second set of points of the second point cloud, noise associated with the collection of the first set of points of the first point cloud and the second set of points of the second point cloud, and point density of the first set of points of the first point cloud and the second set of points of the second point cloud.

13. The method of claim 1, further comprising detecting a collision between the first point cloud and the second point cloud based at least in part on a timestamp associated with each of the first point cloud and the second point cloud.

14. The method of claim 1, further comprising storing the third point cloud to a cloud computing system.

15. A system comprising:
a memory comprising computer readable instructions; and
a processing device for executing the computer readable instructions, the computer readable instructions executed by the processing device to:
receive a first point cloud comprising a first set of points associated with an environment;
receive a segment of a second point cloud comprising a second set of points associated with the environment;
align the segment with the first point cloud;
identify a change between the first point cloud and the segment; and
generating a third point cloud comprising a third set of points based at least in part on the first point cloud, the segment, and the change between the first point cloud and the segment;
wherein generating the third point cloud is further based at least in part on a first quality value associated with the first point cloud and a second quality value associated with the second point cloud, and the first quality value and the second quality value are determined based at least in part on a type of device used to collect the first set of points of the first point cloud and the second set of points of the second point cloud.

16. The system of claim 15, wherein the segment is aligned with the first point cloud by matching points of the second set of points of the segment to corresponding points from the first set of points of the first point cloud using at least one of: markers located within the environment and known feature points within the environment.

17. The system of claim 15, wherein the change is at least one of an element added to the environment, an element removed from the environment, and an element moved within the environment.

18. The system of claim 15, the computer readable instructions further including comparing the change to a change threshold, to determine whether to include the change in the third point cloud, and the change is included in the third point cloud when the change satisfies the change threshold.

19. The system of claim 18, wherein the change threshold is based on at least one of: a number of changed points, a number of changed points within a certain area or volume, a distance, a color difference, and a measurement quality.

20. The system of claim 15, wherein the first set of points are captured at a first point in time, and the second set of points are captured at a second point in time later than the first point in time.
